(19) United States
(12) Patent Application Publication
(10) Pub. No.: US 2008/0030535 A1
(43) Pub. Date: Feb. 7, 2008

(54) Image recording apparatus, ink pre-jetting method and storage medium storing control program for pre-jetting ink

(75) Inventor: Kenichi Okawa, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/881,078

(22) Filed: Jul. 25, 2007

(30) Foreign Application Priority Data
Aug. 1, 2006 (JP) 2006-209583

(51) Int. Cl. B41J 29/38

(52) U.S. Cl. 347/16

(57) ABSTRACT

An image recording apparatus of an inkjet system comprises a first image recording unit for performing a recording process on a first surface of a continuous sheet; a second image recording unit for performing a recording process on the second surface; a conveyance information generating unit for generating conveyance information related to a conveyance amount of the continuous sheet; a control unit for instructing the first image recording unit for performing a first ink pre-jetting process prior to the recording process performed thereby and instructing the second image recording unit for performing a second ink pre-jetting process prior to the recording process performed thereby; and a pre-jetting position detecting unit for detecting a position of the first ink pre-jetting process, wherein the control unit makes a recording process performed on the second surface based on the ink pre-jetting position detection information and the conveyance information.

### CROSS REFERENCE TO RELATED APPLICATIONS

This application claims benefit of Japanese Application No. 2006-209583 filed Aug. 1, 2006, the contents of which are incorporated by this reference.

### BACKGROUND OF THE INVENTION

1. Field of the Invention

The present invention relates to a technique for controlling pre-jetting ink and making recording positions on the front and back matched in case of recording on both sides of a sheet (sometimes noted as “duplex recording” hereinafter) performed at an image recording apparatus of an ink jet system using a rolling sheet, that is, a continuous sheet as a recording medium is rolled a lá roll.

2. Description of the Related Art

In an image recording apparatus of an ink jet system recording an image (i.e., recording process) by jetting an ink from a jet nozzle in a recording head, an ink jet failure may occur as a result of an increased viscosity of the ink in the neighborhood of an ink jet nozzle of the recording head if a state of the recording head not jetting an ink lasts for an extended time. Such a failure of ink jetting causes a degradation of quality of a recorded image in case of recording an image.

Because of this, the image recording apparatus of an ink jet system periodically performs a head cleaning that forcibly jets ink toward an ink pan equipped in a non-recording area or suctions the ink from ink jet nozzles, thereby maintaining the recording head in a normal state.

As one example of performing such a periodical head cleaning, a reference patent document 1 (Laid-Open Japanese Patent Application Publication No. 2004-268511) has disclosed an inkjet recording apparatus comprising a mechanism of an ink pre-jetting for receiving ink droplets jetted from a line head featured with a nozzle array across the width direction of a recording sheet.

The inkjet recording apparatus put forth in the patent document 1 is configured to pre-jetting an ink by equipping a line head rotationally and movably and making a nozzle surface face the ink pan equipped in a position different from a recording surface so as to make the nozzle surface featuring a nozzle array of the line head face a different position from the recording surface, thereby preventing an occurrence of an ink jetting failure.

Also, the inkjet recording apparatus according to the patent document 1 comprises a first line head and a second line head in a plurality of line heads, in which the second line head perform a recording operation in place of the first line head during the time when the first line head performing an ink pre-jetting for a maintenance process, thereby avoiding an interruption of the recording operation.

Meanwhile, a duplex printing apparatus according to a reference patent document 2 (Laid-Open Japanese Patent Application Publication No. 2003-63072) has disclosed a configuration for matching print positions of the front and back in case of a duplex printing in a configuration using a long print sheet as a recording medium.

The duplex printing apparatus according to the patent document 2 is configured to print an identifiable mark on the front surface of a print sheet by using a first printer and detect the aforementioned mark before printing on the back surface by using the second printer, thereby matching the position of an image printed on the front surface with that of an image to be printed on the back side.

The duplex printing apparatus according to the patent document 2 is also configured to print a mark by using a marking apparatus jetting an ink unrecognizable with a human eye if an area (i.e., a margin area) for printing the mark in a printing sheet cannot be secured.

The inkjet recording apparatus according to the patent document 1 performs an ink pre-jetting by moving the nozzle surface of the line head to a position opposite to the ink pan equipped in a different area from the recording surface. The inkjet recording apparatus according to the patent document 1 requires a mechanism for moving the line head rotationally.

The inkjet recording apparatus according to the patent document 1 is further configured to comprise a plurality of line heads for avoiding an interrupt of a recording operation during an ink pre-jetting. The inkjet recording apparatus according to the patent document 1 requires a space for a mechanism for comprising the plurality of line heads.

Meanwhile, the duplex printing apparatus according to the patent document 2 is configured to make the first printer print a mark for matching printing positions on the front and back when performing a duplex printing in a margin area of a print sheet.

The duplex printing apparatus according to the patent document 2 is configured to print a mark by using a marking apparatus jetting an ink unrecognizable with a human eye, in place of a printing or a mark by using the first printer, if an area (i.e., a margin area) for printing the mark in a print sheet cannot be secured.

The duplex printing apparatus according to the patent document 2 must install the marking apparatus when accomplishing a matching of printing positions on the front and back under a condition of being unable to secure the margin area, thus requiring an installation space for the marking apparatus.

### SUMMARY OF THE INVENTION

An image recording apparatus according to one of the aspects of the present invention is one employing an inkjet system using a rolling sheet winding a continuous sheet as a recording medium in a roll, comprising: a first image recording unit for performing a recording process on a first surface of the continuous sheet; a second image recording unit for performing a recording process on the second surface which is the back of the first surface of the continuous sheet; a conveyance unit for conveying the continuous sheet in a conveyance path including a position opposite to the first and second image recording unit; a conveyance information generating unit for generating conveyance information related to a conveyance amount of the continuous sheet; a control unit for instructing the first and second image recording unit for respectively performing the recording process, instructing the first image recording unit for performing a first ink pre-jetting process prior to the recording process performed thereby and instructing the second image recording unit for performing a second ink pre-jetting process prior to the recording process performed thereby; and a pre-jetting position detecting unit for detecting a position of the first ink pre-jetting process on the continuous sheet, wherein the control unit makes the second image recording unit perform a recording process on the second surface based on the ink pre-jetting position detection information detected by the pre-jetting position detecting unit and the conveyance information generated by the conveyance information generating unit.

An ink pre-jetting method according to another of the aspects of the present invention is the method performed by an image recording apparatus of an inkjet system using a rolling sheet rolling a continuous sheet as a recording medium in a roll, comprising: starting a first ink pre-jetting process on a first surface of a continuous sheet, a conveyance of the continuous sheet and an accumulation of conveyance information related to an conveyance amount of the conveyed continuous sheet based on a notification of job information including an instruction for performing a recording process; performing a recording process on the first surface of the continuous sheet based on the accumulated conveyance information; and performing a second pre-jetting process and a recording process both on the second surface which is the back of the first surface of the continuous sheet based on the conveyance information accumulated by the position of the first pre-jetting as a trigger.

A storage medium according to yet another of the aspects of the present invention is one storing a control program for making an arithmetic logical operation processing unit of an information processing apparatus execute an ink pre-jetting process, wherein the control program comprises the processes for starting a first ink pre-jetting on a first surface of a continuous sheet by controlling a first image recording unit, a conveyance of the continuous sheet by controlling a platen driving unit and an accumulation of conveyance information related to an conveyance amount of the conveyed continuous sheet based on a notification of job information including an instruction for performing a recording process; performing a recording process on the first surface of the continuous sheet by controlling the first image recording unit based on the accumulated conveyance information; and performing a second pre-jetting process and a recording process both on the second surface which is the back of the first surface of the continuous sheet by controlling a second image recording unit based on the conveyance information accumulated by detection information, as a trigger, which is the information on a pre-jetting position detecting unit detecting the position of the first ink pre-jetting.

### BRIEF DESCRIPTION OF THE DRAWINGS

FIG. 1 is a diagram illustrating a configuration example of an image recording apparatus according to the present embodiment;

FIGS. 2A and 2B are diagrams describing an ink pre-jetting, a matching of recording positions on the front and back in case of a duplex recording process and a cutting position of a continuous sheet after a duplex recording process at an image recording apparatus according to the present invention;

FIG. 3 is a flow chart of operation processing showing an ink pre-jetting process in the ink pre-jetting method and control program, and a matching of recorded positions on the front and back in case of duplex recording process, according to the present invention;

FIG. 4 is a block diagram illustrating connection status that the individual constituent elements are connected by a bus (including a connection cable) within a control unit according to the present embodiment; and

FIG. 5 is a diagram describing a readout method of a control program stored in a storage medium according to the present invention.

### DESCRIPTION OF THE PREFERRED EMBODIMENTS

The following is a detailed description of the preferred embodiment of the present invention by referring to the accompanying drawings.

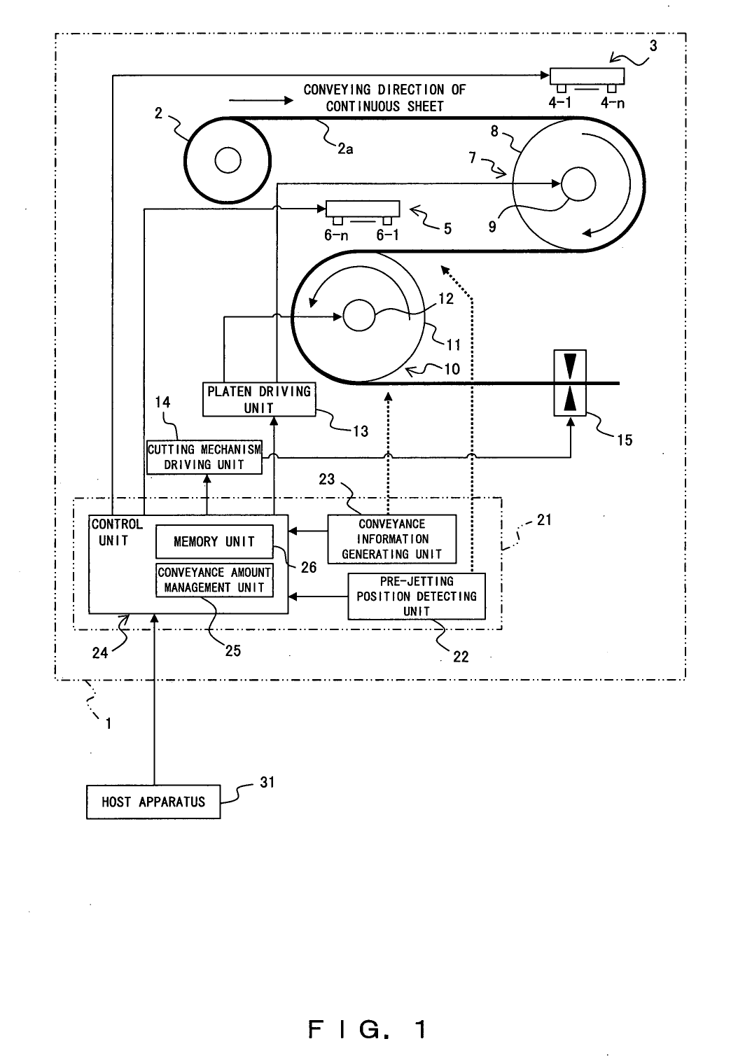

FIG. 1 is a diagram illustrating a configuration example of an image recording apparatus according to the present invention.

The image recording apparatus shown in FIG. 1 at least comprises a first image recording unit 3, a second image recording unit 5, a first platen unit 7, a second platen unit 10, a platen driving unit 13, a cutting mechanism driving unit 14, a cutting mechanism 15 and an ink pre-jetting system 21.

The ink pre-jetting system 21 at least comprises a pre-jetting position detecting unit 22, a conveyance information generating unit 23 and a control unit 24. Furthermore, the control unit 24 at least comprises a conveyance amount management unit 25 and a storage unit 26.

The first platen unit 7 at least comprises a first platen 8 and a first driving mechanism 9 so as to convey a continuous sheet 2a fed out of a rolling sheet 2 winding the continuous sheet 2a in a roll. The second platen unit 10, at least comprising a second platen 11 and a second driving mechanism 12, turns over the front and back of the continuous sheet 2a conveyed from the first platen unit 7 so as to convey the continuous sheet 2a so that the reverse face (noted as “second face” hereinafter) of the face (noted as “first face” hereinafter) which is faced by the first image recording unit 3 is opposite to the second image recording unit 5.

The continuous sheet 2a is fed out of the rolling sheet 2 and conveyed toward the downstream of the conveyance path by the first platen 8 and the second platen 11 which are rotationally driven.

The first image recording unit 3 comprises recording heads 4-1 through 4-n (where the n is an integer no smaller than “2”) featured with a plurality of jet nozzles across the width direction of the continuous sheet 2a for example, arraying in order of ink colors of black (K), cyan (C), magenta (M) and yellow (Y) from the upstream side of the conveyance path of the continuous sheet 2a in an example of n=4.

The first image recording unit 3 jets the ink from the jet nozzles of nozzle arrays featured in the recording heads 4-1 through 4-n as a result of a head drive unit (not shown in a drawing herein) being drive-controlled by the control unit 24, thereby performing a recording process on the face of one side (i.e., the first face) of the conveyed-in the continuous sheet 2a.

The second image recording unit 5 comprises recording heads 6-1 through 6-n in the same basic configuration as that of the first image recording unit 3. The second image recording unit 5 jets the ink from the jet nozzles of nozzle arrays featured in the recording heads 6-1 through 6-n as a result of a head drive unit (not shown in a drawing herein) being drive-controlled by the control unit 24, thereby performing a recording process on the back (i.e., the second face) of the face (i.e., the first face) of the conveyed-in continuous sheet recorded by the first image recording unit 3.

The platen driving unit 13 is constituted by a drive circuit for instructing the first driving mechanism 9 of the first platen unit 7 and the second driving mechanism 12 of the second platen unit 10 for respectively driving on the basis of a control instruction from the control unit 24.

The platen driving unit 13 rotates the first platen 8 of the first platen unit 7 by driving the first driving mechanism 9 and also rotates the second platen 11 of the second platen unit 10 by driving the second driving mechanism 12.

Note that the platen driving unit 13 may alternatively be configured so as to enable an individual drive control of the first driving mechanism 9 and the second driving mechanism 12.

The cutting mechanism driving unit 14 is constituted by a drive circuit for instructing the cutting mechanism 15 for driving itself. The cutting mechanism 15, comprising a cutter for cutting the continuous sheet 2a, cuts it by driving the aforementioned cutter based on an instruction from the cutting mechanism driving unit 14.

The ink pre-jetting system 21 performs the ink pre-jetting process, and the process for matching the recording positions on the front and back in case of a duplex recording, both according to the present invention.

The control unit 24 of the ink pre-jetting system 21 receives a notification of conveyance information generated by the conveyance information generating unit 23 related to the conveyance amount of the continuous sheet 2a.

The control unit 24 of the ink pre-jetting system 21 also receives detection information as a result of the pre-jetting position detecting unit 22 detecting a mark which has been marked by the first ink pre-jetting process on the continuous sheet 2a.

Note that a preferred embodiment of an image recording apparatus according to the present invention is configured so that the control unit 24 controls the entirety of the image recording apparatus 1; alternatively, however, it may comprise individual control units for independently performing the control of the ink pre-jetting system 21 and that of the entirety of the image recording apparatus 1, in lieu of being limited to the embodiment described above.

The pre-jetting position detecting unit 22 is constituted by a sensor which extends to a length of no less than the width of the continuous sheet 2a, which is placed opposite to the continuous sheet 2a fed out of the rolling sheet 2 and conveyed and which detects the positions of the respective ink pre-jetting of the first recording heads 4-1 through 4-n. The sensor of the pre-jetting position detecting unit 22, employing a line sensor or a charge coupled device (CCD) sensor for example, notifies the control unit 24 of detection information of an ink pre-jetting position when detecting the present ink pre-jetting position.

The conveyance information generating unit 23 is configured to notify the control unit 24 of conveyance information related to a conveyance amount of the continuous sheet 2a. The conveyance information generating unit 23, employing a rotary encoder for example, makes the aforementioned encoder generate a pulse signal corresponding to a conveyance amount of the continuous sheet 2a fed out of the rolling sheet 2 by rotating the first platen 8 and the second platen 11, and sends the pulse signal out to the control unit 24.

The control unit 24, being configured as an information processing apparatus controlling the individual constituent components of the image recording apparatus 1 including the ink pre-jetting system 21 and other elements, comprises at least a processing circuit which is constituted, for example, by a Micro Processing Unit (MPU) comprised by an arithmetic logical operation unit possessing a control function and an arithmetic logical operation function, by Read Only Memory (ROM) for storing a control program, and by Random Access Memory (RAM) functioning as the work memory for the MPU, and comprises nonvolatile memory for storing a setup value and such which are related to the control of the image recording apparatus 1.

A preferred embodiment of an image recording apparatus according to the present invention is configured to make the above described the conveyance amount management unit 25 as a control program executed by the arithmetic logical operation unit of the control unit 24 or a signal processing circuit, and constitute the above described the storage unit 26 as a nonvolatile memory.

The next is a detailed description on the control unit 24 described above.

At this point, a host apparatus 31 is described before describing the conveyance amount management unit 25 and the storage unit 26.

The host apparatus 31, being equivalent to an information processing apparatus (i.e., a host computer) which is connected as external equipment of the image recording apparatus 1 according to the present invention by way of a local area network (LAN) or such for example, notifies the present image recording apparatus 1 of job information related to a recording process including an instruction for the recording process for each user.

The job information includes: the record data of character information and image information for performing a recording process; information of “the number of sheets of recording processes” which is a set-up number of sheets of recording the record data in a recording medium (i.e., the continuous sheet 2a); instruction information for the first and second ink pre-jetting processes; and a blank area value on a recording medium until a recording process is carried out after performing the ink pre-jetting process.

The blank area value includes a setup value for specifying an interval, in the conveyance direction, between the record data to be sequentially recorded on the continuous sheet 2a and the blank area value is set by an accumulated value of encoder pulse signals at the above described the conveyance information generating unit 23.

Note that a job information setup table which is set by the host apparatus 31 is set by installing driver software of the image recording apparatus 1 in the host apparatus 31 for example.

The storage unit 26 pre-stores, as the number in terms of the design and production of the image recording apparatus 1, information on a separation distance (i.e., the distance between one nozzle array position and another nozzle array position; which is noted as “separation distance information” hereinafter) between individual color recording heads for each of the first image recording unit 3 and the second image recording unit 5 in the case of respectively arraying the recording heads 4-1 through 4-n of the first image recording unit 3 and the recording heads 6-1 through 6-n in the sequence of the ink colors of black (K), cyan (C), magenta (M) and yellow (Y) from the upstream side of the conveyance path of the continuous sheet 2a.

The storage unit 26 also pre-stores, as the number in terms of the design and production of the image recording apparatus 1, a separation distance between the above described the pre-jetting position detecting unit 22 and nozzle positions of a plurality of jet nozzles in the recording head 6-1 of the second image recording unit 5.

Furthermore, the storage unit 26 also pre-stores, as the number in terms of the design and production of the image recording apparatus 1, a separation distance between the detection position of the above described the pre-jetting position detecting unit 22 and the cutting position of the cutting mechanism 15, that is the information on the separation distance which is the distance of a mark of an ink pre-jetting on the continuous sheet 2a being conveyed to the cutting position of the cutting mechanism 15.

Note that each piece of the separation distance information is converted into an accumulation value of an encoder pulse signal(s) at the above described the conveyance information generating unit 23, and stored individually.

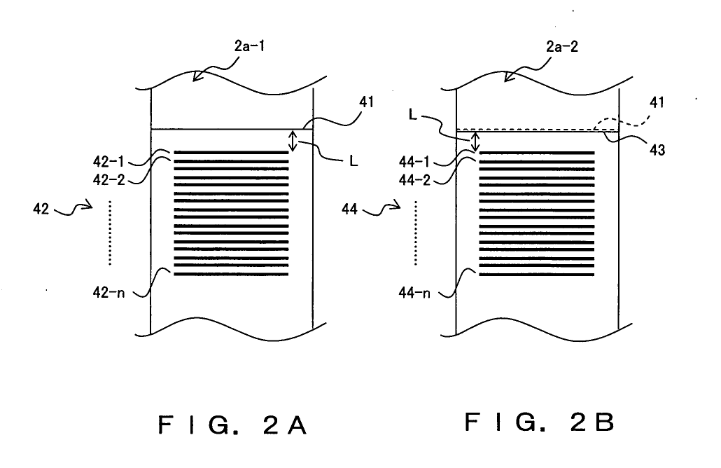

The next is a description of the control contents of the conveyance amount management unit 25 by referring to FIG. 2.

Note that the description here exemplifies a configuration in which the first image recording unit 3 and the second image recording unit 5 respectively array the color recording heads in order of black (K), cyan (C), magenta (M) and yellow (Y) from the upstream side of the conveyance path.

FIG. 2 shows diagrams describing an ink pre-jetting, a matching of recording positions on the front and back in case of a duplex recording process and a cutting position of a continuous sheet after a duplex recording process at an image recording apparatus according to the present invention.

Having received a notification of the job information including an instruction from the host apparatus 31 for a recording process, the conveyance amount management unit 25 executed by the arithmetic logical operation unit of the control unit 24 makes the K-recording head 4-1 of the first image recording unit 3 record a mark 41 on the first face 2a-1 of the continuous sheet 2a by performing a K-ink pre-jetting and also makes the first platen 8 and the second platen 11 rotate and convey the continuous sheet 2a by driving the platen driving unit 13. This prompts the conveyance amount management unit 25 to start accumulating pulse signal(s) generated, and reported to the control unit 24, by the rotary encoder at the conveyance information generating unit 23 as a result of conveying the continuous sheet 2a.

Note that the recording of the mark 41 by an ink pre-jetting may be a single line recording, or may allow a setup of plural lines by instructing as job information, as a value in terms of the design and production of the image recording apparatus 1.

Then, the conveyance amount management unit 25 makes the control unit 24 notify the first image recording unit 3 of a recording process of record data 42 (i.e., 42-1 through 42-n line record data, where the n is an integer of no smaller than “2”) in accordance with the job information at a timing of matching between the blank area value L (i.e., an accumulation value of the number of encoder pulses) in accordance with the job information and the accumulation value of the pulse signals generated by the conveyance information generating unit 23.

And, the conveyance amount management unit 25 refers to a pulse number value related to the separation distance between the K-recording head 4-1 and C-recording head 4-2 stored in the storage unit 26, and makes the C-recording head 4-2 pre-jetting the C-ink onto the first face 2a-1 of the continuous sheet 2a at the time of matching between the number of accumulation pulses generated by the conveyance information generating unit 23 and the stored pulse number value, thereby recording with the C-ink overlapped on the mark 41 recorded with the K-ink.

As the subsequent operation processing, the conveyance amount management unit 25 makes the M-recording head 4-3 and Y-recording head 4-4 of the first image recording unit 3 likewise perform respective ink pre-jetting processes for recording with the M- and Y-inks overlapped on the mark 41 of the overlapping K- and C-inks, as the respective M- and Y-ink pre-jetting, and recording processes with the respective color inks, thereby completing the recording of the record data 42.

Note that the mark 41 recorded by the respective color pre-jetting processes is recorded in the full width of the continuous sheet 2a for example, thereby avoiding an increased viscosity of ink against plural jet nozzles of the individual color recording heads 4-1 through 4-4 for example.

Then, the conveyance amount management unit 25 makes the pre-jetting position detecting unit 22 detect the mark 41 related to the ink pre-jetting of the continuous sheet 2a conveyed at the completion of the ink pre-jetting process and recording process performed by the first image recording unit 3 and notify the control unit 24 of the detection information.

When the control unit 24 receives the detection information notified from the pre-jetting position detecting unit 22, the conveyance amount management unit 25 starts accumulating, by using the detection information as a trigger, a pulse signal(s) generated by the conveyance information generating unit 23.

And, the conveyance amount management unit 25 makes the K-recording head 6-1 record a mark 43 by a K-ink pre-jetting onto the second face 2a-2 of the continuous sheet 2a at a timing of matching between the accumulation value of pulse signals generated by the conveyance information generating unit 23 using the detection information as a trigger and the separation distance from the above described the pre-jetting position detecting unit 22 to the nozzle array position in the recording head 6-1 of the second image recording unit 5, which is pre-stored in the storage unit 26.

As the subsequent operation processing, the conveyance amount management unit 25 makes the C-recording head 6-2, M-recording head 6-3 and Y-recording head 6-4 record by overlapping on the mark 43 as the respective ink pre-jetting, likewise the above described ink pre-jetting process performed by the first image recording unit 3.

And the conveyance amount management unit 25 makes the control unit 24 notify the second image recording unit 5 of a recording process of record data 44 (i.e., 44-1 through 44-n lines record data, where the n is an integer of no less than “2”) in accordance with the job information at the timing of matching between the accumulation value of pulse signals generated by the conveyance information generating unit 23 using the detection information as a trigger and the blank area value L (i.e., an accumulation value of the number of encoder pulses) in accordance with the above described job information.

As the subsequent operation processing, the conveyance amount management unit 25 makes the second image recording unit 5 perform an ink pre-jetting process and a recording process likewise the first image recording unit 3, thereby completing the recording of the record data 44.

Then, the conveyance amount management unit 25 makes the control unit 24 drive the cutting mechanism driving unit 14 at the timing of matching between the accumulation value of a pulse signal(s) generated by the conveyance information generating unit 23 using the detection information from the pre-jetting position detecting unit 22 as a trigger and the separation distance information from the pre-jetting position detecting unit 22 to the cutting position of the cutting mechanism 15.

This prompts the conveyance amount management unit 25 to make the cutting mechanism 15 cut the continuous sheet 2a at the position of the mark 43 (and the mark 41) marked by the respective ink pre-jetting.

The next is a description on the ink pre-jetting method and control program performed by the image recording apparatus according to the present invention.

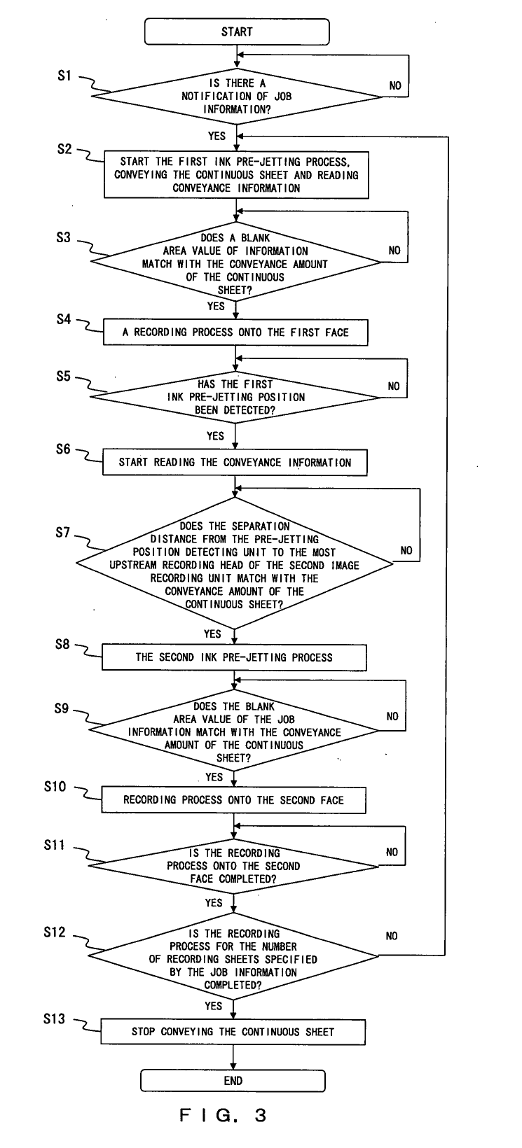

FIG. 3 is a flow chart of operation processing by a control program for performing an ink pre-jetting, and a matching of recorded positions on the front and back in case of performing a duplex recording process, according to the ink pre-jetting method and storage medium of the present invention.

Note that the configuration described here is that the first image recording unit 3 comprises only the recording head 4-1 and that the second image recording unit 5 comprises only the recording head 6-1.

The operation processing of FIG. 3 shows one in the case of configuring the above described the conveyance amount management unit 25 by a control program which is functioned as the conveyance amount management unit 25 by the control unit storing the control program and then by the arithmetic logical operation unit of the control unit 24 reading and executing the control program.

Note also that the operation processing of FIG. 3 is such that, even if the above described the conveyance amount management unit 25 is constituted by a signal processing circuit and by a control program controlling the aforementioned signal processing circuit, these functions as the conveyance amount management unit 25 by the control program being read and executed by the arithmetic logical operation unit of the control unit 24.

When the process of FIG. 3 is started, the arithmetic logical operation unit of the control unit 24 first judges whether the host apparatus 31 has notified the image recording apparatus 1 of jog information in the step S1 and, if the judgment is that there is no notification of job information (“no” for the step S1), stands by for a process in the step S1.

In the step S1, the arithmetic logical operation unit of the control unit 24 shifts the process to the step S2, if the judgment is that there has been a notification of job information (“yes” for the step S1).

In the step S2, the arithmetic logical operation unit of the control unit 24 makes the control unit 24 carry out the first ink pre-jetting process at the first recording head 4-1, a conveyance of the continuous sheet 2a and a start of reading an encoder pulse signal(s) at the conveyance information generating unit 23.

In the step S3, the arithmetic logical operation unit of the control unit 24 judges whether or not the blank area value L (i.e., the accumulation value of the number of encoder pulses) related to the above described job information stored in the storage unit 26 matches with (i.e., the record timing at recording head 4-1) the accumulation value of the pulse signal(s) generated by the conveyance information generating unit 23 related to the continuous sheet 2a.

The arithmetic logical operation unit of the control unit 24 stands by to carry out a process until the aforementioned two values match with each other in the step S3 if the judgment is that they do not match (“no” for the step S3).

In the step S3, if the judgment is that the blank area value L (i.e., the accumulation value of the number of encoder pulses) matches with the accumulation value of the pulse signals generated by the conveyance information generating unit 23 related to the continuous sheet 2a (“yes” for the step S3), the arithmetic logical operation unit of the control unit 24 shifts the process to the step S4 and makes the control unit 24 perform a recording process on the first face by the recording head 4-1.

In the step S5, the arithmetic logical operation unit of the control unit 24 judges whether or not the pre-jetting position detecting unit 22 has detected the first ink pre-jetting position of the continuous sheet 2a conveyed as a result of completing the first ink pre-jetting process and recording process performed by the first image recording unit 3 and, if the judgment is that the first ink pre-jetting position is not detected (“no” for the step S5), stands by a process in the step S5.

In the step S5, if the judgment is that the pre-jetting position detecting unit 22 has detected the first ink pre-jetting position (“yes” for the step S5), the arithmetic logical operation unit of the control unit 24 shifts the process to the step S6 makes the control unit 24 restart to read the pulse signal(s) generated by the conveyance information generating unit 23 using the ink pre-jetting position detection information as a trigger.

Then, the arithmetic logical operation unit of the control unit 24 judges whether or not the above described separation distance from the pre-jetting position detecting unit 22 to the nozzle array position of the recording head 6-1 of the second image recording unit 5 matches with the accumulation value of the pulse signals generated by the conveyance information generating unit 23 using the ink pre-jetting position detection information as a trigger.

If the judgment is that the aforementioned two values do not match (“no” for the step S7), the arithmetic logical operation unit of the control unit 24 stands by a process until they match with each other.

In the step S7, if the judgment is that the above described separation distance from the pre-jetting position detecting unit 22 to the nozzle array position of the recording head 6-1 of the second image recording unit 5 matches with the accumulation value of the pulse signals generated by the conveyance information generating unit 23 related to the conveyance value of the continuous sheet 2a (“yes” for the step S7), the arithmetic logical operation unit of the control unit 24 shifts the process to the step S8 and makes the control unit 24 carry out the second ink pre-jetting process performed by the recording head 6-1.

In the step S9, the arithmetic logical operation unit of the control unit 24 judges whether or not the above described blank area value L (i.e., the accumulation value of the number of encoder pulses) relating to the job information stored in the storage unit 26 matches (i.e., the recording timing at the recording head 6-1) with the accumulation value of the pulse signals generated by the conveyance information generating unit 23 related to the conveyance amount of the continuous sheet 2a.

If the judgment is that the aforementioned two values do not match (“no” for the step S9), the arithmetic logical operation unit of the control unit 24 stands by a process until they match with each other.

In the step S9, if the judgment is that the blank area value L (i.e., the accumulation value of the number of encoder pulses) matches with the accumulation value of the pulse signals generated by the conveyance information generating unit 23 related to the conveyance amount of the continuous sheet 2a (“yes” for the step S9), the arithmetic logical operation unit of the control unit 24 shifts the process to the S10 and makes the control unit 24 carry out a recording process onto the second face performed by the recording head 6-1.

In the step S11, the arithmetic logical operation unit of the control unit 24 judges whether or the recording process onto the second face is complete and, if the judgment is that the recording process onto the second face is not complete (“no” for the step S11), stands by a process until the recording process onto the second face is completed.

In the step S11, if the judgment is that the recording process onto the second face is completed (“yes” for the step S11), the arithmetic logical operation unit of the control unit 24 shifts the process to the step S12.

In the step S12, the arithmetic logical operation unit of the control unit 24 judges whether or not the recording process for the number of recording sheets specified by the job information is complete and, if the judgment is that it is not complete (“no” for the step S12), shifts the process to the step S2 and repeats the processes of the steps S2 through S11, thereby accomplishing the first and second ink pre-jetting processes and the recording processes onto the first and second faces of the continuous sheet 2a for the specified number of recording sheets.

In the step S12, the arithmetic logical operation unit of the control unit 24 shifts the process to the step S13 if the judgment is that the recording processes for the number of recording sheets specified by the job information are completed (“yes” for the step S12).

In the step S13, the arithmetic logical operation unit of the control unit 24 makes the control unit 24 control the platen driving unit 13 and stop rotating the first platen 8 and the second platen 11 to stop conveying the continuous sheet 2a, thereby completing the present process.

Note that the first and second ink pre-jetting processes in accordance with the conveyance amount management unit 25 of the present embodiment are configured to be carried out for each recording process of the first image recording unit 3 and the second image recording unit 5; it may be configured, however, to carry out after recording the number of prescribed recording sheets as a result of a set of the job information for example and yet prior to the recording processes performed by the first and second image recording units 3 and 5.

Here, the operation processing referring to FIG. 3 has been described for the first and second ink pre-jetting processes and the matching of the recording positions on the front and back in case of a duplex recording process; the control program related to the ink pre-jetting method and storage medium of the present invention includes the operation processing of the cutting mechanism 15 comprised by the image recording apparatus 1 according to the present invention.

The operation processing at the cutting mechanism 15 is carried out in a parallel processing with the first and second ink pre-jetting processes and the recording process onto the first face and that onto the second face after completing the process of the above described step S9 instructed by the control unit 24 in accordance with the conveyance amount management unit 25.

The arithmetic logical operation unit of the control unit 24 makes the control unit 24 drive the cutting mechanism driving unit 14 at the timing of matching the accumulation value of the pulse signals generated by the conveyance information generating unit 23 using the detection information from the pre-jetting position detecting unit 22 with the information of the separation distance from the pre-jetting position detecting unit 22 to the cutting position of the cutting mechanism 15.

By this, the arithmetic logical operation unit of the control unit 24 makes the cutting mechanism 15 cut the continuous sheet 2a at the position of the first and second pre-jetting.

The next is a detailed description of the control unit of the image recording apparatus according to the present embodiment.

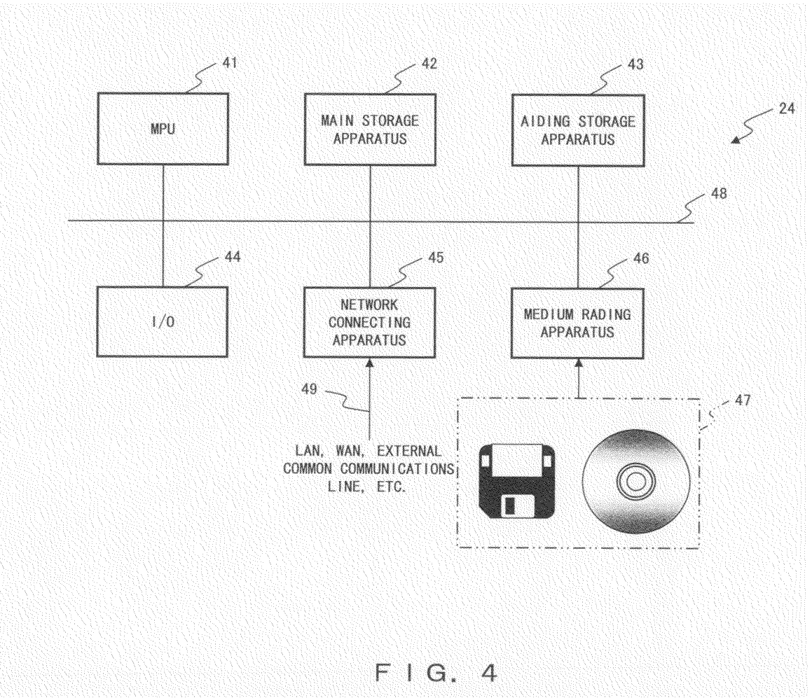

FIG. 4 is a block diagram illustrating a connection status that the individual constituent elements are connected by a bus (including a connection cable) within a control unit according to the present embodiment.

The control unit 24 comprises a bus 48 (including a connection cable) which interconnects an MPU 41, a main storage apparatus 42 such as RAM, ROM, hard disk or the like, an auxiliary storage apparatus 43 such as EPROM that is nonvolatile memory, an input/output (I/O) apparatus 44, a network connecting apparatus 45 such as a modem for connecting a network line 49 such as an external common communications line, LAN and wide area network (WAN), and a medium reading apparatus 46 for reading a storage content from a storage medium 47 such as a magnetic tape, flexible disk, CD-ROM and MO.

The control unit 24 makes the medium reading apparatus 46 read, under the control of the MPU, the control program for performing the ink pre-jetting process stored in a storage medium 47, and further makes the main storage apparatus 42 or auxiliary storage apparatus 43 store under the control of the MPU.

Note that the control unit 24 makes the main storage apparatus 42 or auxiliary storage apparatus 43 store the control program for performing the ink pre-jetting process stored in a storage medium 47 according to the present invention by way of the network connecting apparatus 45 under the control of the MPU.

A storage medium read by the medium reading apparatus 46 may use a large capacity storage medium including various medium which are developed how and in the future, including the next generation optical disk medium employing a blue laser such as Blue-ray Disk (a registered trademark) and Advanced Optical Disk (AOD), HD-DVD employing a red laser, and Blue Laser DVD employing a blue violet laser, and the like, in addition to a CD-ROM, DVD-ROM, flexible disk (including MO, DVD and removable disk).

The next is a description on a readout method for a control program for carrying out the ink pre-jetting process stored in the storage medium as a description thereof according to the present invention.

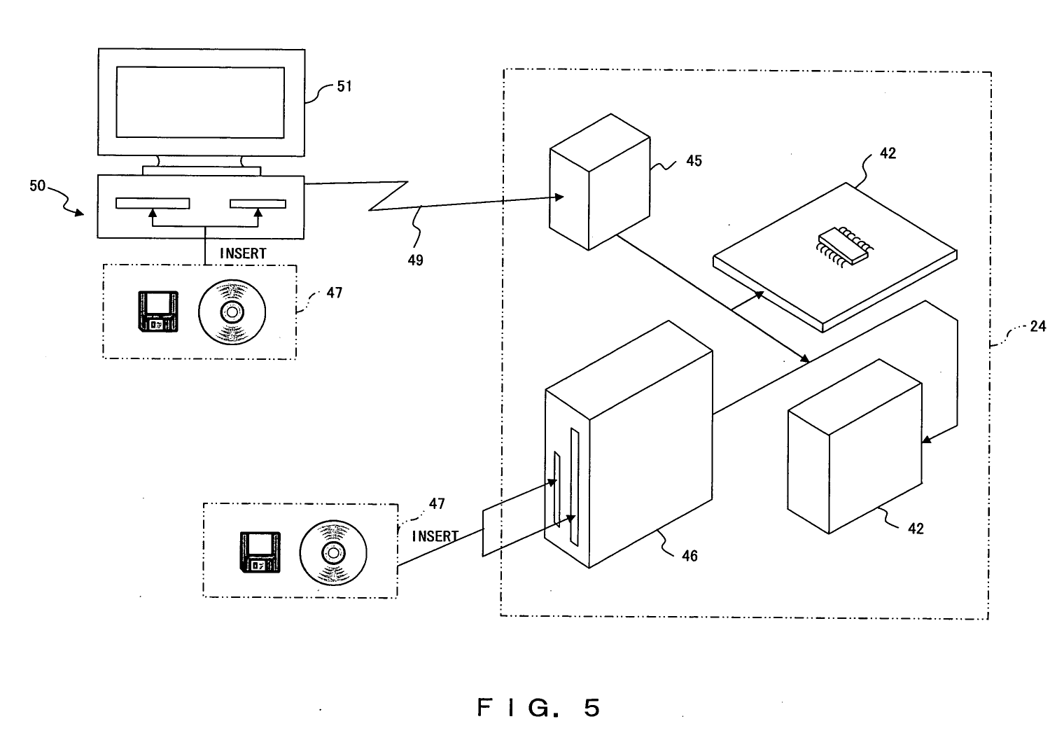

FIG. 5 describes a readout method of a control program stored in a storage medium according to the present invention.

FIG. 5 shows the relationship among a provider 50 of the control program comprising an information processing apparatus 51, the control unit 24 of the image recording apparatus 1 according to the present invention and the storage medium 47 according to the present invention storing the control program for performing the ink pre-jetting process at the image recording apparatus 1 according to the present invention.

FIG. 5 also shows two methods as the ones for making the control unit 24 of the image recording apparatus 1 read the control program stored by the storage medium 47 according to the present invention.

A first method is one for making the network connecting apparatus 45 of the control unit 24 read, by way of the network line 49, the control program which the provider 50 thereof pre-reads from the storage medium 47 of the information processing apparatus 51.

And the second method is one for making the medium reading apparatus 46 of the control unit 24 by inserting the storage medium 47, as the medium according to the present invention, storing the control program for carrying out an ink pre-jetting process at the image recording apparatus 1.

As such, the storage medium 47 according to the present invention provides the control program for carrying out the ink pre-jetting process which is stored in the storage medium 47 by making the control unit 24 of the image recording apparatus 1 according to the present invention.

As described above, the present invention is contrived to make a plurality of jet nozzles of each recording head of the first image recording unit 3 and the second image recording unit 5 carry out respective ink pre-jetting processes prior to a recording process onto the first face of the continuous sheet 2a and prior to a recording process onto the second face which is the back of the first face of the continuous sheet 2a.

This contrivance enables an avoidance of a degradation of a recording quality due to an increased viscosity of the ink in the neighborhood of a jet nozzle or the like problem.

Also, the present invention is contrived to carry out the first ink pre-jetting process performed by the first image recording unit 3 onto the first face of the continuous sheet 2a and the second ink pre-jetting process performed by the second image recording unit 5 onto the second face which is the back of the first face of the continuous sheet 2a.

By this configuration, the present invention makes it possible to eliminate an ink pan and an auxiliary recording head for an ink pre-jetting process and accomplish a matching of a start position of a recording process onto the first face of the continuous sheet 2a performed by the first image recording unit 3 with that of a recording process onto the second face that is the back of the first face of the continuous sheet 2a performed by the second image recording unit 5 without equipping a marking apparatus jetting an ink unrecognizable by a human eye.

Furthermore, the present invention is contrived to cut the continuous sheet 2a of a result of the first image recording unit 3 and the second image recording unit 5, respectively, at the first and second ink pre-jetting positions which are the same position on the front and back of the continuous sheet 2a, thereby leaving no trace of the ink pre-jetting around the edge of the continuous sheet after the cutting (i.e., in the vicinity of the cut face).

What is claimed is:

1. An image recoding apparatus of an inkjet system using a rolling sheet rolling a continuous sheet as a recording medium in a roll, comprising:
a first image recording unit for performing a recording process on a first surface of the continuous sheet;
a second image recording unit for performing a recording process on the second surface which is the back of the first surface of the continuous sheet;
a conveyance unit for conveying the continuous sheet in a conveyance path including a position opposite to the first and second image recording units;
a conveyance information generating unit for generating conveyance information related to a conveyance amount of the continuous sheet;
a control unit for instructing the first and second image recording units for respectively performing the recording process, instructing the first image recording unit for performing a first ink pre-jetting process prior to the recording process performed thereby and instructing the second image recording unit for performing a second ink pre-jetting process prior to the recording process performed thereby; and
a pre-jetting position detecting unit for detecting a position of the first ink pre-jetting process on the continuous sheet, wherein
the control unit makes the second image recording unit perform a recording process on the second surface based on the ink pre-jetting position detection information detected by the pre-jetting position detecting unit and the conveyance information generated by the conveyance information generating unit.

2. The image recoding apparatus according to claim 1, wherein
the control unit stores a conveyance amount management unit, as a control program, for making a control of the present control unit perform the respective recording processes of the first and second image recording units, the first ink pre-jetting process and the second ink pre-jetting process.

3. The image recoding apparatus according to claim 2, wherein
the conveyance amount management unit comprises a signal processing circuit controlled by the control unit.

4. The image recoding apparatus according to claim 1, further comprising
a cutting mechanism for cutting the continuous sheet, wherein
the control unit makes the cutting mechanism cut the continuous sheet at the ink pre-jetting position at which the first ink pre-jetting and the second ink pre-jetting have been performed.

5. The image recoding apparatus according to claim 1, wherein
the first image recording unit is placed on the upstream side of the second image recording unit in the conveyance path of the continuous sheet.

6. The image recoding apparatus according to claim 1, wherein
the control unit matches the start position of the recording process performed by the first image recording unit with that of the recording process performed by the second image recording unit based on the ink pre-jetting position detection information and the conveyance information of the conveyance information generating unit.

7. The image recoding apparatus according to claim 1, wherein
the pre-jetting position detecting unit is placed on the downstream side of the first image recording unit and on the upstream side of the second image recording unit in the conveyance path of the continuous sheet.

8. The image recoding apparatus according to claim 1,
a host apparatus as external equipment is connected, and job information instructed by receiving from the host apparatus includes the first ink pre-jetting process performing by the first image recording unit, the recording process performing by the first image recording unit, the second ink pre-jetting process performing by the second image recording unit, and the recording process performing by the second image recording unit.

9. The image recoding apparatus according to claim 1, wherein
the job information includes the recorded data recorded on the continuous sheet by the first image recording unit and second image recording unit, and a blank area value which is set on the basis of the recorded position of the ink pre-jetting recorded on the continuous sheet by the first ink pre-jetting process.

10. An ink pre-jetting method performed by an image recording apparatus of an inkjet system using a rolling sheet rolling a continuous sheet as a recording medium in a roll, comprising:
starting a first ink pre-jetting process on a first surface of a continuous sheet, a conveyance of the continuous sheet and an accumulation of conveyance information related to an conveyance amount of the conveyed continuous sheet based on a notification of job information including an instruction for performing a recording process;
performing a recording process on the first surface of the continuous sheet based on the accumulated conveyance information; and
performing a second pre-jetting process and a recording process both on the second surface which is the back of the first surface of the continuous sheet based on the conveyance information accumulated by the position of the first pre-jetting as a trigger.

11. The ink pre-jetting method according to claim 10, further comprising
cutting the continuous sheet at the position of the first ink pre-jetting of the continuous sheet in which a first ink pre-jetting is performed on the first surface of the continuous sheet.

12. A storage medium storing a control program for making an arithmetic logical operation processing unit of an information processing apparatus execute an ink pre-jetting process, wherein
the control program comprises the processes for
starting a first ink pre-jetting on a first surface of a continuous sheet by controlling a first image recording unit, a conveyance of the continuous sheet by controlling a platen driving unit and an accumulation of conveyance information related to an conveyance amount of the conveyed continuous sheet based on a notification of job information including an instruction for performing a recording process;
performing a recording process on the first surface of the continuous sheet by controlling the first image recording unit based on the accumulated conveyance information; and
performing a second pre-jetting process and a recording process both on the second surface which is the back of the first surface of the continuous sheet by controlling a second image recording unit based on the conveyance information accumulated by detection information, as a trigger, which is the information on a pre-jetting position detecting unit detecting the position of the first ink pre-jetting.

13. The storage medium according to claim 12, wherein
the control program further comprises the process for making the arithmetic logical operation processing unit perform, by it controlling a cutting mechanism, the process for cutting the continuous sheet at the position of the first ink pre-jetting of the continuous sheet in which a first ink pre-jetting is performed on the first surface of the continuous sheet.
